(19) United States
(12) Patent Application Publication
(10) Pub. No.: US 2009/0017987 A1
(43) Pub. Date: Jan. 15, 2009

(54) Control Method and Control Device for Engine

(75) Inventors: Shinya Satou, Hitachinaka (JP); Kunihiko Suzuki, Hitachinaka (JP); Mamoru Nemoto, Hitachiota (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/169,196

(22) Filed: Jul. 8, 2008

(30) Foreign Application Priority Data
Jul. 10, 2007 (JP) 2007-180439

(51) Int. Cl. F16H 59/74

(52) U.S. Cl. 477/102

(57) ABSTRACT

In a control method and control device for an engine, in order to prevent torque control precision from deteriorating while performing an ignition retard control in a variable valve engine, when a torque down control is carried out by using the ignition retard, combustion duration is calculated in consideration of valve timing or an engine rpm for each driving state, and a characteristic of a reference ignition timing efficiency curve is corrected on the basis of a difference between the combustion duration and a combustion duration reference value which is set in advance.

### FIELD OF THE INVENTION

The present invention relates to a control device for an engine mounted to a vehicle.

### DESCRIPTION OF RELATED ART

A variable valve system has been noted for a technique concerned with a gasoline engine for a vehicle. The variable valve system variably controls valve timing or valve-lift amount in accordance with a driving state. Specifically, the variable valve system varies the valve timing or the valve-lift amount in accordance with the driving state by providing a hydraulic or electric actuator at a position around a cam shaft fixed portion of an engine. The variable valve system is advantageous in that fuel efficiency is improved by reducing a pump loss or exhaust gas such as HC or NOx is reduced by adjusting a valve overlap.

Meanwhile, a high-response torque down control using an ignition retard is known as another technique concerned with the gasoline engine for the vehicle. The high-response torque down control using the ignition retard indicates a control that the engine torque down is carried out in such a manner that torque generation efficiency is lowered by delaying ignition timing with respect to the reference ignition timing. This high-response torque down control can be effectively used when performing a fuel-cut and a high-speed engine torque down.

Here, a relationship between the ignition timing and the engine generation torque will be described. As shown in FIGS. 14A to 14D, a crank angle when combustion pressure (cylinder pressure) within a cylinder reaches a peak varies in accordance with the ignition timing. If the ignition timing is set so that the combustion pressure reaches a peak when the crank angle is located at 10 to 15 degree after the top dead center (TDC), the engine generation torque becomes a maximum value. In addition, the ignition timing at that time is called MBT (Minimum advanced for the Best Torque).

When the ignition retard is carried out on the basis of the MBT, the engine torque reduces in accordance with the ignition retard. A relationship between the ignition retard amount and the formal engine torque (MBT reference torque generation efficiency) corresponds to a relationship of a quadratic curve shown in FIG. 15 (which is called an ignition timing efficiency curve). Accordingly, when the torque down is carried out by using the ignition retard, generally an ignition retard amount with respect to a desired torque down rate (called MBT reference torque generation efficiency) is calculated on the basis of the relationship of ‘ignition retard amount—MBT reference torque generation efficiency’ which is prepared as a formula or a table in advance. The relationship of ‘ignition retard amount—MBT reference torque generation efficiency’ is obtained by using a practical examination or a simulator. JP-A-10-89214 discloses a torque down control technique which is carried out by using an ignition timing efficiency table in consideration of a difference between the basic igniting timing and the MBT.

At this time, it is assumed that the relationship of ‘ignition retard amount—MBT reference torque generation efficiency’ in JP-A-10-89214 is constant irrespective of an engine rpm or an engine load. This is based on an experimental rule of a conventional engine with a fixed cam mechanism without the variable valve timing mechanism. However, in an engine with the variable valve which variably controls the valve timing or the valve-lift amount in accordance with the driving range, a combustion speed of mixed gas largely varies due to a variation in an internal EGR amount (exhaust gas recirculation amount) in accordance with a valve overlap expansion or the like. As a result, the relationship of ‘ignition retard amount—MBT reference torque generation efficiency’ easily changes in accordance with the driving range. Accordingly, when the ignition retard control is carried out by using a single ignition timing efficiency table, a problem arises in that precision of the engine torque control deteriorates because it is not possible to cope with a variation in ignition timing efficiency.

### BRIEF SUMMARY OF THE INVENTION

The present invention is to solve the above-described problems, and an object of the invention is to provide high-precise engine torque control means by efficiently correcting torque generation efficiency with respect to an ignition retard amount.

According to an aspect of the invention, there is provided a control method for an engine which performs an engine torque control by an ignition retard on the basis of a relationship between an ignition retard amount and engine torque generation efficiency, wherein the relationship between the ignition retard amount and the engine torque generation efficiency is corrected on the basis of information on combustion duration within a cylinder of the engine.

According to the invention, it is possible to realize the high-precise engine torque control means by accurately and efficiently correcting the torque generation efficiency with respect to the ignition retard.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a diagram illustrating a hardware configuration of an engine control system.

FIG. 2 is a diagram illustrating an outline of a variable valve system.

FIG. 3 is an entire control block diagram of a torque base-type engine control.

FIG. 4 is a diagram illustrating a relationship between an accelerator opening degree and driver request torque.

FIG. 5 is a diagram illustrating a relationship between the number of fuel-cut cylinders and a fuel-cut torque correction rate.

FIG. 6 is a diagram illustrating calculation contents of an ignition retard amount calculating unit 229 according to Embodiment 1 of the present invention.

FIG. 7 is a diagram illustrating calculation contents of ignition timing efficiency according to the Embodiment 1.

FIG. 8 is a diagram illustrating calculation contents of a combustion duration calculating unit 303 according to the Embodiment 1.

FIG. 9 is a diagram illustrating calculation contents of an ignition retard amount calculating unit 229 according to Embodiment 2 of the invention.

FIG. 10 is a diagram illustrating calculation contents of a combustion duration calculating unit 303 according to the Embodiment 2.

FIG. 11 is a diagram illustrating calculation contents of the combustion duration calculating unit 303 according to Embodiment 3 of the invention.

FIG. 12 is a diagram illustrating a hardware configuration of an engine control system according to Embodiment 4 of the invention.

FIG. 13 is a diagram illustrating calculation contents of a combustion duration calculating unit 303 according to the Embodiment 4.

FIGS. 14A to 14D are diagrams illustrating a relationship between ignition timing and cylinder pressure.

FIG. 15 is a diagram illustrating a relationship between ignition retard amount and torque generation efficiency.

FIGS. 16A and 16B are diagrams illustrating relationships between combustion duration and an ignition timing efficiency curve.

FIG. 17 is a diagram illustrating a relationship between ignition retard amount and torque generation efficiency upon using a bioethanol.

### DETAILED DESCRIPTION OF THE INVENTION

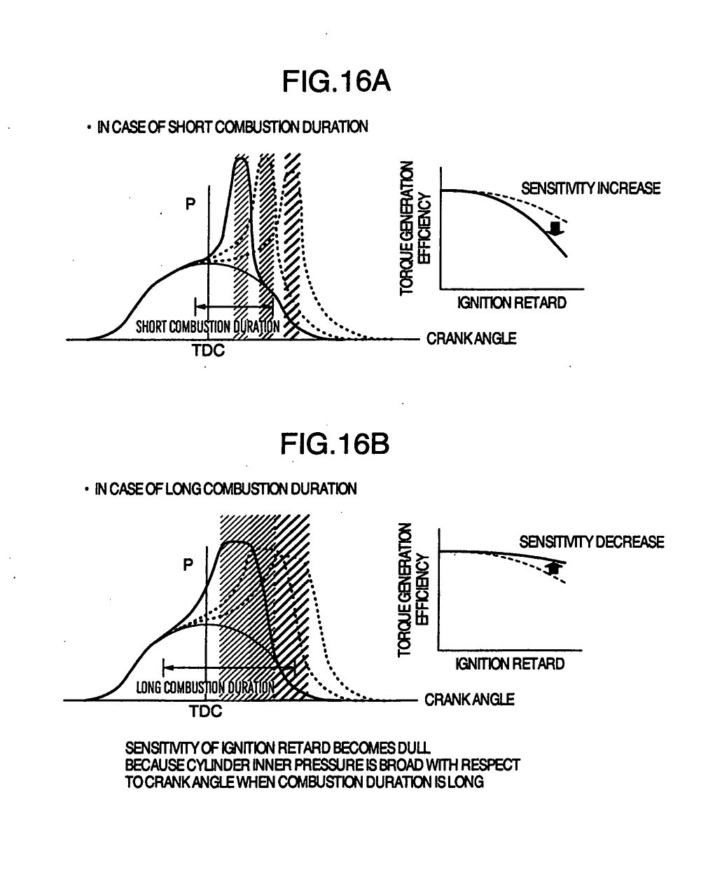

As shown in FIG. 16B, when a combustion speed decreases due to an increase of an internal ERG or the like, combustion duration (a crank angle from a combustion start time to a combustion end time) becomes long. A curve indicating a combustion pressure becomes broad with respect to the crank angle. Consequently, torque sensitivity with respect to an ignition retard becomes relatively alleviated. That is, an ignition timing efficiency curve is largely dependent on the combustion duration.

However, in a conventional fixed cam mechanism engine, a flame propagation speed (velocity) is approximately proportional to an engine rpm. Accordingly, it may be assumed that the combustion duration is approximately constant irrespective of a driving condition, and thus it may be assumed that the highly relevant ignition timing efficiency curve is approximately constant. Meanwhile, in a variable valve engine, when a valve overlap is actively changed from a reference value in a viewpoint of fuel efficiency or exhaust, the combustion duration and the ignition timing efficiency curve vary due to a variation in internal EGR.

Accordingly, when a torque down control is carried out by an ignition retard, an algorithm is effective in which the combustion duration is calculated in consideration of valve timing or an engine rpm for each driving state and a characteristic of the ignition timing reference efficiency curve is corrected on the basis of a difference information between the combustion duration and a combustion duration reference value which is set in advance.

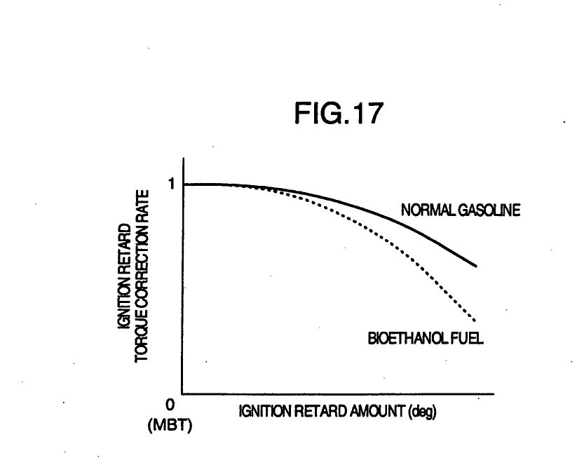

In addition, although bioethanol fuel such as E10 or E85 has been noted for alternative fuel, a combustion speed of the alternative fuel is faster than that of gasoline and sensitivity of the ignition timing efficiency curve of the alternative fuel tends to more increase than that of gasoline as shown in FIG. 17. Accordingly, when the present algorithm based on the combustion duration is applied to a flexible fuel vehicle (FFV) operable to use E85 or the like as well as general gasoline, an ignition retard control with comprehensively high precision can be realized in terms of a single algorithm without complex processes which increase the ignition timing efficiency map in accordance with an alcohol containing ratio.

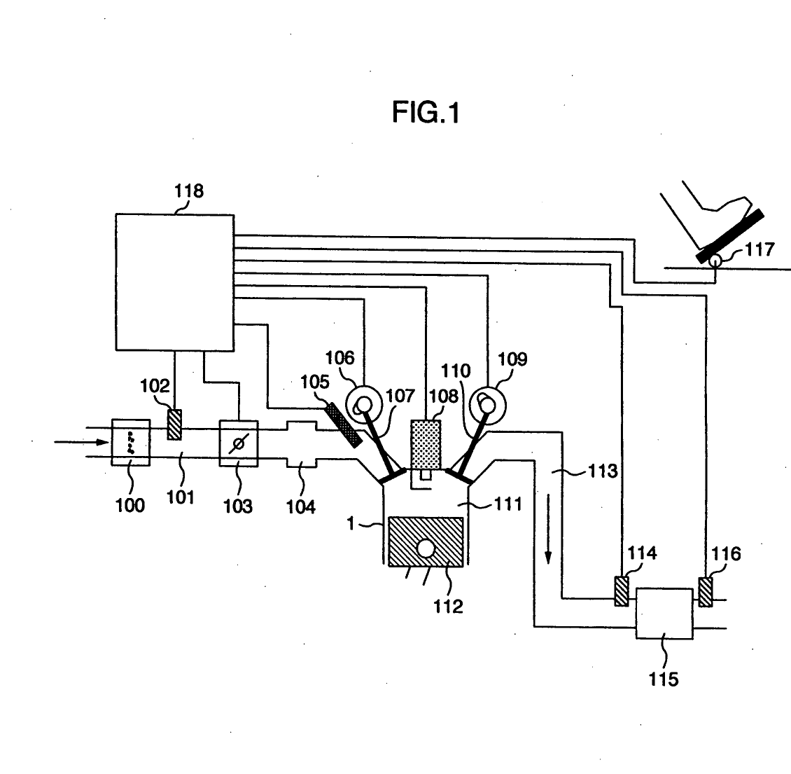

First, a hardware configuration of a gasoline engine 1 mounted with a variable valve mechanism for a vehicle as a control target will be described with reference to FIG. 1. An engine control unit 118 (hereinafter, referred to as an ECU 118) determines a target valve opening degree of an electronic control throttle valve (hereinafter, referred to as an electronic throttle) 103 in accordance with a pressed amount of an accelerator which a driver presses, and transmits an opening degree instruction value to the electronic throttle 103. When the electronic throttle 103 realizes the target valve opening degree in accordance with the instruction value, a negative pressure occurs in an intake pipe and thus air enters into the intake pipe.

The air taken in from an inlet of the intake pipe 101 passes through an air cleaner 100 and an intake amount of the air is measured by an air flow sensor 102. Subsequently, the air is introduced into an inlet of the electronic throttle 103. In addition, the measurement value obtained by the air flow sensor 102 is transmitted to the ECU 118, and a fuel injection pulse width-of an injector 105 is calculated so that an air/fuel ratio becomes a theoretical air/fuel ratio on the basis of the measurement value. The intake air passed through the electronic throttle 103 passes through a collector 104 and then is introduced into an intake manifold. Subsequently, the air is mixed with the gasoline spray injected from the injector 105 in accordance with the fuel injection pulse width so as to be an air-fuel mixture. Subsequently, the air-fuel mixture is introduced into a combustion chamber 111 in synchronization with opening and closing of an intake valve 107. Subsequently, the air-fuel mixture compressed during a rise of a piston 112 by closing the intake valve 107 is ignited by a spark plug 108 at a position just before the compressed TDC in accordance with the ignition timing instructed by the ECU 118. Subsequently, the air-fuel mixture expands rapidly to press down the piston 112, thereby generating engine torque.

Subsequently, an exhaust cycle is started from the time when the exhaust valve 110 is opened after the piston 112 rises, and exhaust gas is discharged into an exhaust manifold 113. A three-way catalyst 115 is provided at a position on the downstream side of the exhaust manifold 113 so as to purify the exhaust. When the exhaust gas passes through the three-way catalyst 115, exhaust constituents HC, CO, and NOx are changed into H₂O, CO₂, and N₂, respectively. In addition, a broadband air/fuel ratio sensor 114 and an O₂ sensor 116 are installed at an inlet and an outlet of the three-way catalyst 115, respectively. The air/fuel ratio information measured by the sensors 114 and 116 is transmitted to the ECU 118. The ECU 118 performs a feedback control of the air/fuel ratio by adjusting a fuel injection amount on the basis of the information so that the air/fuel ratio becomes approximately the theoretical air/fuel ratio.

The instruction value of the electronic control throttle valve opening degree is set on the basis of a target engine torque calculated by the ECU 118 described below. In addition, the fuel injection pulse width may be set to 0 in some cylinder according to the target engine torque (fuel-cut). In the same way, the ignition timing is set to timing around the MBT at a normal time, but the ignition timing may be set to a delay side according to the target engine torque (ignition retard).

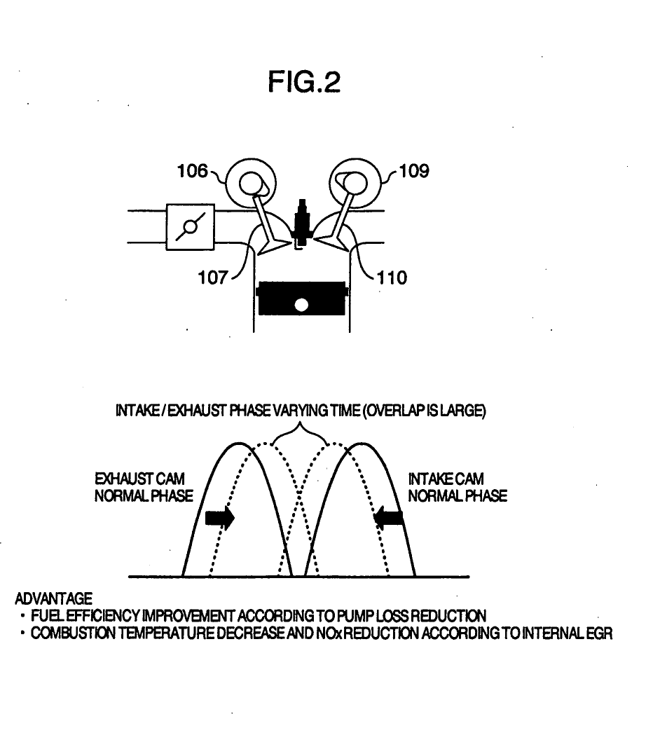

In addition, open or close timing of the intake valve 107 and the exhaust valve 110 is determined by cam phases of an intake cam shaft 106 and an exhaust cam shaft 109, respectively. In this embodiment, the intake cam shaft 106 and the exhaust cam shaft 109 are provided with a cam phase angle changing actuator which is driven by a hydraulic pressure, and the cam phase is changed on the basis of an instruction value calculated by the ECU 118 in accordance with a driving condition. As shown in FIG. 2, as an exemplary technique for obtaining an appropriate cam phase angle, in a low revolution/low load zone, a valve overlap is set to be larger than a normal valve overlap in such a manner that an angle of the intake cam advances with respect to a reference phase angle and an angle of the exhaust cam retards with respect to the reference phase angle. Accordingly, it is possible to improve fuel efficiency according to a pump loss reduction and to reduce NOx according to a combustion temperature reduction in accordance with an increase of an internal EGR.

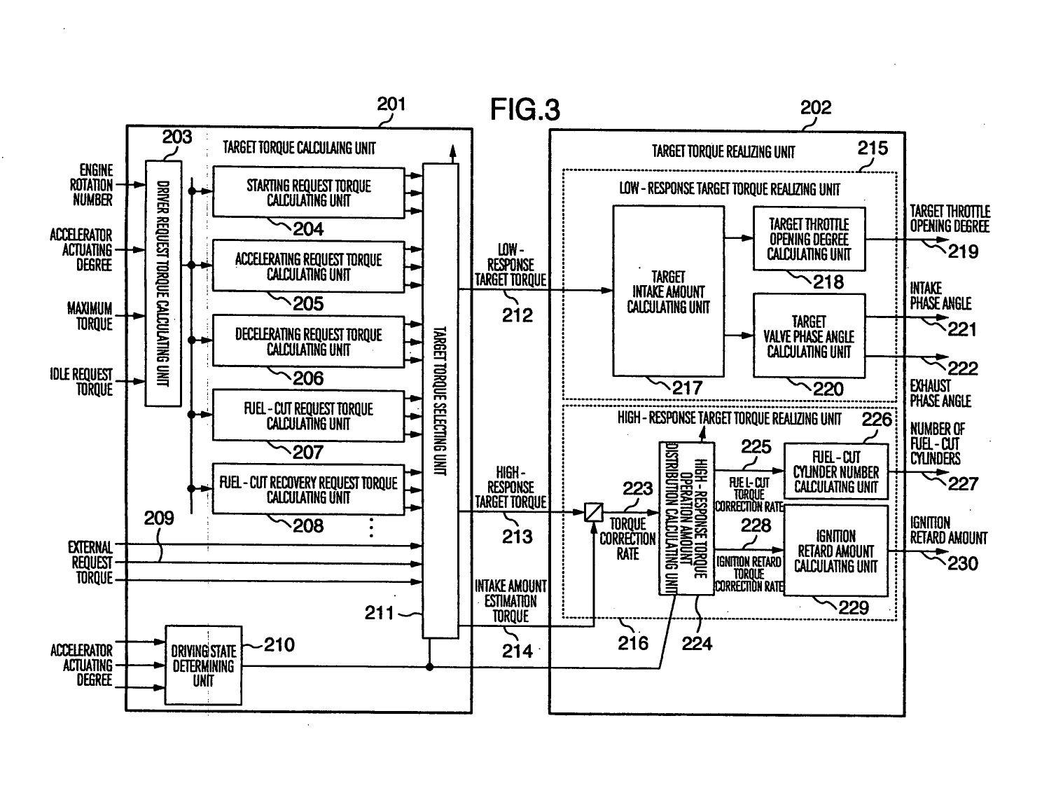

Next, an entire control block of a torque base-type (torque demand-type) engine control corresponding to the engine configuration will be described with reference to FIG. 3. The engine control block mainly includes a target torque calculating unit 201 and a target torque realizing unit 202. The target torque calculating unit 201 includes therein a driving state determining unit 210 and a driver request torque calculating unit 203 which calculates a basic request torque corresponding a driver's accelerator operation.

The driver request torque calculating unit 203 calculates driver's request engine torque on the basis of maximum torque, idle request torque, and an engine rpm as well as an accelerator opening degree (measured by accelerator pedal sensor 117). Specifically, as shown in FIG. 3, the driver request torque calculating unit 203 calculates the request torque so as to realize a torque characteristic approximately equivalent to a mechanic throttle +an ISC valve system. That is, the driver request torque calculating unit 203 calculates the idle request torque when the accelerator is fully closed, gradually increases the request torque so as to be convex upward when the accelerator opening degree increases, and then finally calculates the maximum torque at the current engine rpm when the accelerator is fully opened.

The driving state determining unit 210 determines a driving state for each circumstance in accordance with an accelerator opening degree, a vehicle speed, or an existence of external request torque 209. In addition, request torque calculating unit group 204 to 208 are installed at the rear stage of the driver request torque calculating unit 203 so as to respectively calculate starting request torque, accelerating request torque, decelerating request torque, fuel-cut request torque, and fuel-cut recovery request torque for improving driving performance during a transition on the basis of the driver request torque. A target torque selecting unit 211 is further installed at the rear stage of the request torque calculating unit group 204 to 208 so as to select the optimal request torque of the vehicle among the request torque calculated by the request torque calculating unit group 204 to 208 and the external request torque 209 such as a traction control or a cruise control in accordance with the determination result of the driving state determining unit 210. The target torque selecting unit 211 outputs two types of selected target engine torques (low-response target torque 212 and high-response target torque 213) and intake amount estimation torque 214 corresponding to an estimate value of the engine torque when it is assumed that only the intake control is carried out.

The target torque realizing unit 202 includes therein a low-response target torque realizing unit 215 necessary for realizing a low-speed torque control using the electronic throttle and the valve phase angle and a high-response target torque realizing unit 216 necessary for realizing a high-speed torque control using the ignition retard or the fuel-cut. The low-response target torque realizing unit 215 includes therein a target intake amount calculating unit 217 which calculates a target intake amount necessary for realizing the low-response target torque 212. A target throttle opening degree calculating unit 218 and a target valve phase angle calculating unit 220 are installed at the rear stage of the target intake amount calculating unit 217 so as to realize a target intake amount. The target throttle opening degree calculating unit 218 calculates the target throttle opening degree 219, and then transmits the target throttle opening degree 219 to the electronic throttle 103. In addition, the target valve phase angle calculating unit 220 calculates an intake phase angle 221 and an exhaust phase angle 222, and then transmits the intake phase angle 221 and the exhaust phase angle 222 to the intake cam shaft 106 and the exhaust cam shaft 109, respectively.

Meanwhile, in the high-response target torque realizing unit 216, a torque operation amount distribution calculating unit 224 calculates a desired torque operation rate on the basis of torque correction rate 223 obtained by dividing the high-response target torque 213 by the intake amount estimation torque 214, and then transmits the torque operation rate to be a target to a fuel-cut cylinder number calculating unit 226 and an ignition retard amount calculating unit 229.

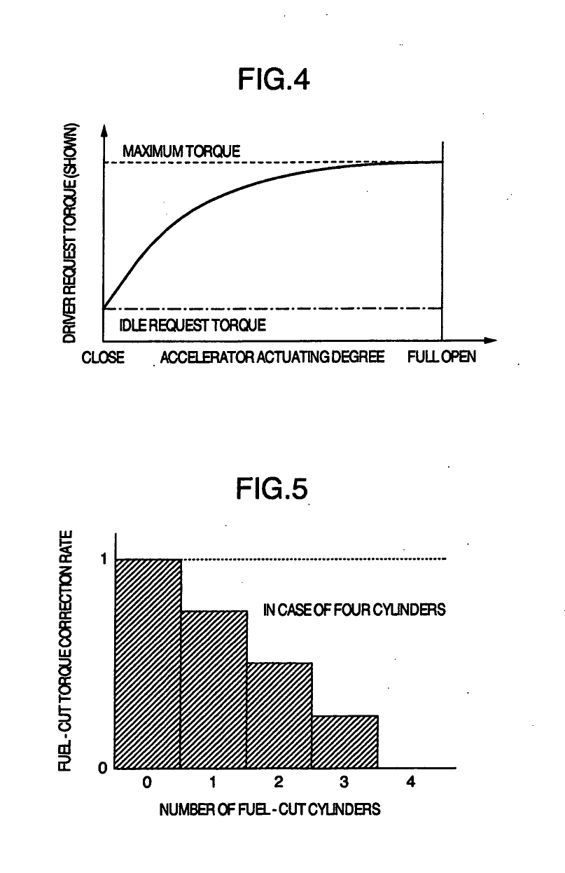

The fuel-cut cylinder number calculating unit 226 calculates the number of fuel-cut cylinders 227 in accordance with a transmitted fuel-cut torque correction rate 225, and then transmits the calculation result to a fuel injection control calculating unit (not shown). Specifically, the fuel-cut cylinder number calculating unit 226 calculates the number of fuel-cut cylinders from the fuel-cut torque correction rate 225 on the basis of a characteristic shown in FIG. 4.

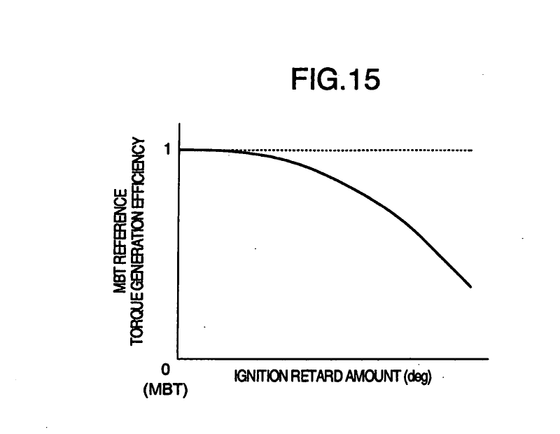

Meanwhile, the ignition retard amount calculating unit 229 calculates an ignition retard amount 230 in accordance with a transmitted ignition retard torque correction amount 228 in the same way, and then transmits the calculation result to an ignition timing control calculating unit (not shown). Specifically, the ignition retard amount calculating unit 229 calculates the ignition retard amount from the ignition retard torque correction rate 228 on the basis of a characteristic shown in FIG. 15. In addition, the driving state determining unit 210 determines the torque operation rate with respect to fuel and ignition.

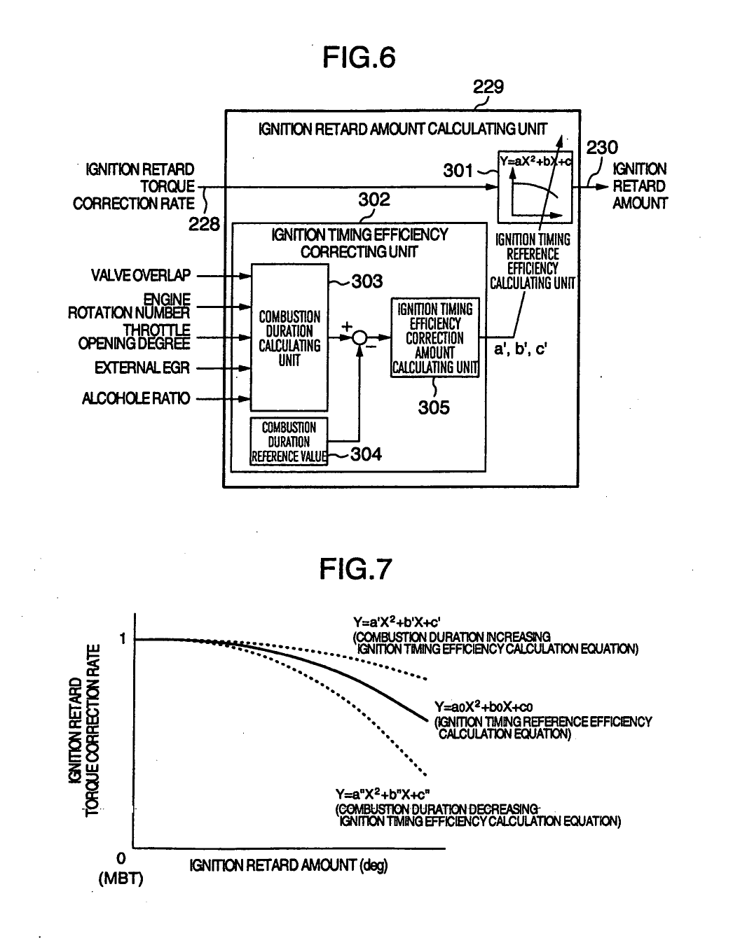

Next, Embodiment 1 according to the invention applied to the torque base-type engine control will be described with reference to FIGS. 6 to 8. FIG. 6 shows the ignition retard amount calculating unit 229 which calculates a desired ignition retard amount 230 on the basis of the input ignition retard torque correction rate 228. The ignition retard amount calculating unit 229 includes an ignition timing reference efficiency calculating unit 301 and an ignition timing efficiency correcting unit 302 which corrects the ignition timing efficiency.

As shown in FIG. 7, the ignition timing reference efficiency calculating unit 301 formulates a reference relationship between the ignition retard amount and the torque generation efficiency as a quadratic function “Y=a₀X²+b₀X+C₀”. In addition, the quadratic function is not fixed, and the respective coefficients thereof are corrected when an ignition timing correction amount calculating unit 305 requests a correction. The correction is carried out such that the respective coefficients are corrected so that a curvature of the quadratic function becomes small when the combustion duration increases, and the respective coefficients are corrected so that the curvature of the quadratic function becomes large when the combustion duration decreases.

The ignition timing efficiency correcting unit 302 includes a combustion duration calculating unit 303, a combustion duration reference value 304, and an ignition timing efficiency correction amount calculating unit 305. The combustion duration calculating unit 303 calculates the combustion duration for each driving state on the basis of the valve overlap or the engine rpm. The combustion duration reference value 304 is a reference combustion duration corresponding to the reference ignition timing efficiency curve, and a difference between the combustion duration reference value 304 and a result calculated by the combustion duration calculating unit 303 is input to the ignition timing efficiency correction amount calculating unit 305. The ignition timing efficiency correcting amount calculating unit 305 transmits a correction instruction of the coefficients of the quadratic function to the ignition timing reference efficiency calculating unit 301 in accordance with the difference and an algorithm for correcting a curvature of the quadratic function.

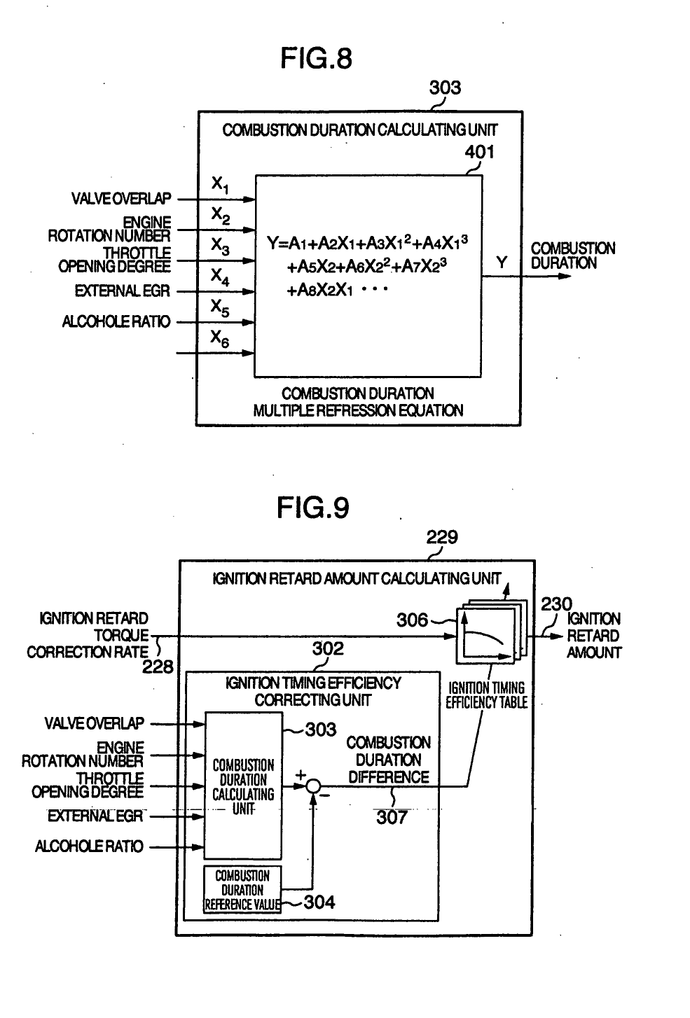

The combustion duration calculating unit 303 will be described in detail with reference to FIG. 8. A valve overlap (X₁), an engine rpm (X₂), a throttle opening degree (X₃), an external EGR amount (X₄), and an alcohol containing ratio (X₅) obtained from the exhaust gas concentration sensor are used as input parameters for the combustion duration calculation. A relationship of combustion duration (Y) obtained by a practical examination or a simulator is formulated by, for instance, the following multiple regression equation 401 so as to calculate the combustion duration for each driving state.

Y=A₁+A₂X₁+A₃X₁²+A₄X₁³+A₅X₂+A₆X₂²+A₇X₂³+A₈X₂X₁ (1)

In addition, a swirl index or a tumble index concerned with the intake may be used as the input parameters.

As described above, even when the valve timing changes, it is possible to perform the torque down control by use of high-precise ignition retard in such a manner that the combustion duration is calculated in consideration of the valve timing or the engine rpm for each driving state and a characteristic of the ignition timing reference efficiency curve is corrected on the basis of a difference between the combustion duration and the combustion duration reference value which is set in advance. Specifically, for instance, when the combustion duration changes due to factors such as a variation in valve timing, an operation of an external EGR valve, an operation of a swirl (tumble) valve, and a variation in engine rpm while the engine torque control is carried out by operating the ignition timing so as to realize the constant target engine torque, it is possible to prevent precision of the torque down control from deteriorating due to the ignition by correcting the ignition timing operation amount (ignition retard amount) on the basis of the ignition timing efficiency curve which is corrected in consideration of the changed combustion duration.

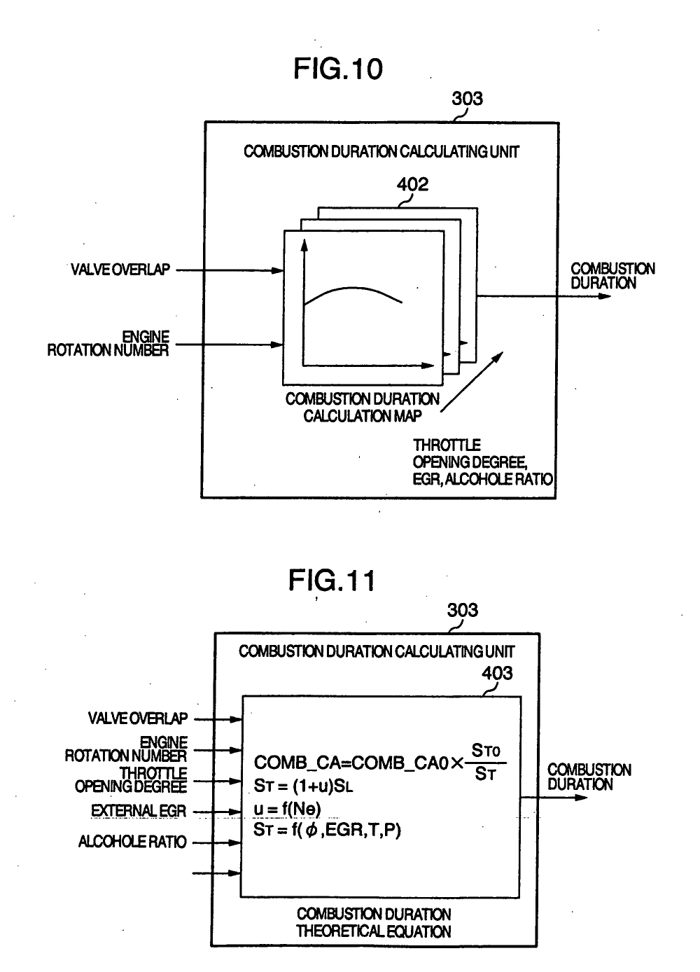

Next, Embodiment 2 of the invention will be described with reference to FIGS. 9 and 10. FIG. 9 shows the ignition retard amount calculating unit 229 according to Embodiment 2. In Embodiment 2, a relationship between the ignition retard amount and the torque generation efficiency are stored in a plurality of ignition timing efficiency tables 306 instead of the quadratic function. One table of the calculation table groups is an ignition timing reference efficiency table serving as a reference for the ignition timing operation and the other table is an ignition timing efficiency table for correcting combustion duration used when the combustion duration largely varies compared with the reference combustion duration. The ignition timing efficiency curve table is changed in accordance with a combustion duration difference 307 as a difference between the combustion duration calculated by the combustion duration calculating unit 303 and the combustion duration reference value 304.

Next, the combustion duration calculating unit 303 according to Embodiment 2 will be described with reference to FIG. 10. Although the combustion duration is calculated by using the multiple regression equation in Embodiment 1, the combustion duration is calculated by using a multidimensional combustion duration calculation map 402 in Embodiment 2. In this Embodiment, the valve overlap and the engine rpm are used as parameters of the map, and the map is created as a multidimensional map in accordance with the throttle opening degree, the external EGR, and the alcohol containing ratio. However, the combination of the parameters is not limited thereto, and may use other combinations or other parameters.

In Embodiment 2, the ignition timing efficiency and the combustion duration use the classical multidimensional table and map. The number of processes is not appropriate, but the calculation algorithm is stable.

Next, the contents of the combustion duration calculating unit 303 related to Embodiment 3 will be described with reference to FIG. 11. In this Embodiment, the combustion duration is calculated by using a combustion duration theoretical equation 403 as a theoretical equation for calculating the combustion duration, and a turbulence combustion speed ST as a main parameter is expressed by the following equation.

S_{T}=(1+u)S_{L} (2)

u=f(Ne, ,) (3)

S_{L}=f(Φ, EGR, T, P, ,) (4)

At this time, u: turbulence intensity, S_{L}: laminar burning speed (velocity), Ne: engine rpm, Φ: equivalent ratio, EGR: exhaust gas remaining ratio, T: cylinder temperature, and P: pressure in the cylinder.

Combustion duration COMB_CA is expressed by the following equation:

COMB_{—}CA=COMB_{—}CA0×(S_{T0}/ST) (5)

wherein the combustion duration corresponding to the ignition timing reference efficiency curve is denoted by COMB_CA0 and the turbulence combustion speed at that time is denoted by S_{T0}.

The theoretical calculation equation is appropriate for a multidimensional input calculation, and when precision of a combustion speed modeling is adjusted, it is possible to expect more improved precision of an ignition timing efficiency correction compared with the above-described Embodiment.

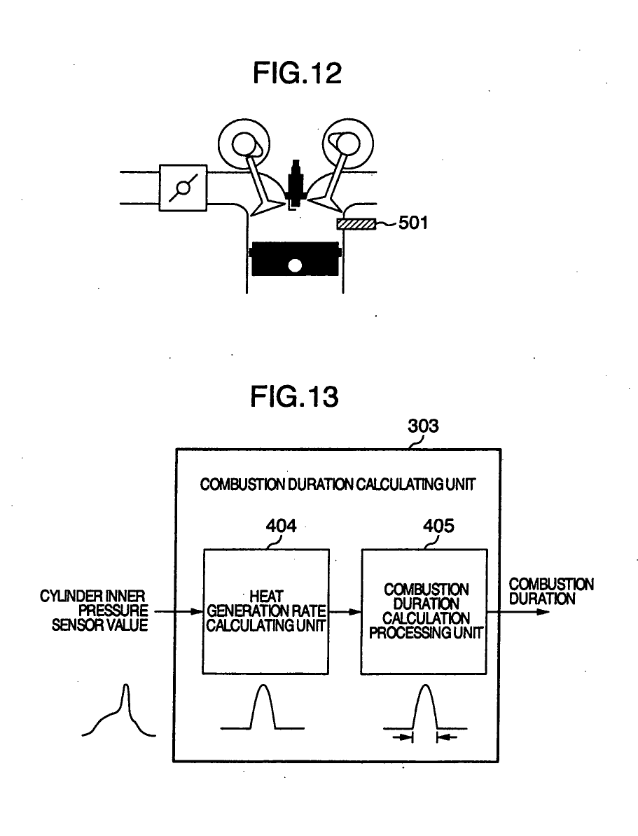

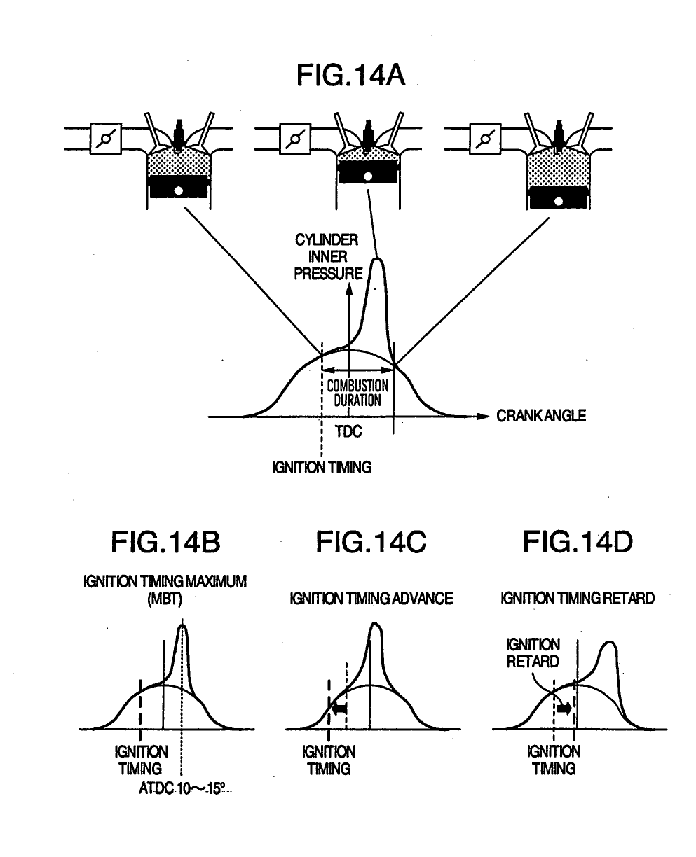

Finally, Embodiment 4 will be described with reference to FIGS. 12 and 13. In this embodiment, as shown in FIG. 12, a cylinder pressure sensor 501 is installed at the engine 1. The combustion duration calculating unit 303 shown in FIG. 13 calculates the combustion duration by performing a signal process of the value obtained by the cylinder pressure sensor 501. The combustion duration calculating unit 303 includes therein a heat generation rate calculating unit 404 and a heat generation rate processing unit 405. The heat generation rate calculating unit 404 calculates the heat generation rate on the basis of the A/D converted cylinder pressure value. The heat generation rate processing unit 405 calculates the combustion duration on the basis of the calculated heat generation rate.

Although cost increases because the cylinder pressure sensor is used in Embodiment 4, it is advantageous in that the combustion duration can be accurately calculated in any circumstance.

It should be further understood by those skilled in the art that although the foregoing description has been made on embodiments of the invention, the invention is not limited thereto and various changes and modifications may be made without departing from the spirit of the invention and the scope of the appended claims.

1. A control method for an engine which performs an engine torque control by an ignition retard on the basis of a relationship between an ignition retard amount and engine torque generation efficiency,
wherein said relationship is corrected on the basis of information on combustion duration within a cylinder of said engine.

2. The control method for the engine according to claim 1, wherein a combustion duration reference value corresponding to said relationship is set in advance, and
wherein an ignition timing efficiency relational expression is corrected on the basis of a difference between the combustion duration obtained directly or indirectly and said combustion duration reference value.

3. The control method for the engine according to claim 1, wherein when said combustion duration is larger than said combustion duration reference value, an ignition timing efficiency relational expression is corrected so that sensitivity of an ignition timing decreases, and
wherein when said combustion duration is smaller than said combustion duration reference value, the ignition timing efficiency relational expression is corrected so that the sensitivity of the ignition timing increases.

4. The control method for the engine according to claim 1, wherein the combustion duration of the engine is calculated on the basis of at least one of a valve timing, a valve overlap, an engine rpm, a throttle opening degree, an intake pipe pressure, an intake pipe temperature, a swirl index, a tumble index, an EGR amount, and an alcohol/fuel ratio.

5. The control method for the engine according to claim 1, wherein the combustion duration of the engine is calculated on the basis of a multidimensional map or a multiple regression equation.

6. The control method for the engine according to claim 1, wherein the combustion duration of the engine is calculated on the basis of a value obtained by a cylinder pressure sensor.

7. A control device for an engine which performs an engine torque control by an ignition retard on the basis of a relationship between an ignition retard amount and engine torque generation efficiency, the control device comprising:
an information obtaining unit which obtains information on combustion duration within a cylinder of the engine; and
a relationship correcting unit which corrects the relationship on the basis of the information.

8. The control device for the engine according to claim 7, further comprising:
a combustion duration reference value setting unit which sets a combustion duration reference value corresponding to said relationship in advance; and
a relationship correcting unit which corrects the relationship on the basis of a difference between the combustion duration obtained directly or indirectly and the combustion duration reference value.

9. The control device for the engine according to claim 7, wherein when the combustion duration is larger than the combustion duration reference value, an ignition timing efficiency relational expression is corrected so that sensitivity of an ignition timing decreases, and
wherein when the combustion duration is smaller than the combustion duration reference value, the ignition timing efficiency relational expression is corrected so that the sensitivity of the ignition timing increases.

10. The control device for the engine according to claim 7, wherein the combustion duration of the engine is calculated on the basis of at least one of a valve timing, a valve overlap, an engine rpm, a throttle opening degree, an intake pipe pressure, an intake pipe temperature, a swirl index, a tumble index, an EGR amount, and an alcohol/fuel ratio.

11. The control device for the engine according to claim 7, wherein the combustion duration of the engine is calculated on the basis of a multidimensional map or a multiple regression equation.

12. The control device for the engine according to claim 7, wherein the combustion duration of the engine is calculated on the basis of a value obtained by a cylinder pressure sensor.
